(19) United States
(12) Patent Application Publication
(10) Pub. No.: US 2009/0248704 A1
(43) Pub. Date: Oct. 1, 2009

(54) ALTERNATIVE WORK SPACE ASSIGNMENT PORTAL

(75) Inventors: John C. Greenwell, (US); Doug Wilson, (US)

Correspondence Address: LAW OFFICES OF EUGENE M. CUMMINGS, P.C., ONE NORTH WACKER DRIVE, SUITE 4130, CHICAGO, IL, 60606, US

(73) Assignee: Continental Electrical Construction Company, LLC

(21) Appl. No.: 12/046,174

(22) Filed: Mar. 31, 2008

(51) Int. Cl. G06F 17/30

(52) U.S. Cl. 707/100; 707/E17.001

(57) ABSTRACT

An alternative work space assignment system, method and apparatus are disclosed. This system accesses a plurality of databases, including a workspace database, a building database, and a corporate database, to better select a suitable temporary workspace. In addition, the system can also select a suitable temporary workspace based on a user's preferences, which can be entered through a kiosk, or otherwise stored in a database record associated with the user.

### FIELD OF THE INVENTION

The present invention relates generally to systems, apparatus, and methods for assigning work spaces, such as offices or cubicles, to workers using a shared facility, and more specifically to systems, apparatus, and methods for utilizing a building's information systems and corporate information systems to better assign temporary work spaces to workers using a shared facility.

### DESCRIPTION OF THE PRIOR ART

Alternative Work Space (“AWS”) systems are well known in the prior art. Generally, AWS systems assign temporary work spaces to workers that share a facility, but do not necessarily require a full-time work space. For example, a sales person may travel ten to twenty days a month, and therefore, assigning a fulltime work space would underutilize valuable office space. By using an AWS system, the sales person could obtain a workspace whenever the sales person was physically present at his or her home facility, and another employee could use the workspace when the sales person was not there. The use of AWS systems results in significant cost savings for those companies that are situated to take advantage of them. However, AWS systems are not without flaws.

Most employees prefer to have their own permanent assigned work spaces. Some portion of this preference derives from human nature, i.e., a desire for privacy, etc., and cannot reasonably be addressed by an improved AWS system. However, other problems that contribute to employee discontent with AWS systems can be addressed. Present AWS systems do not provide a convenient way for employees to maintain a consistent phone number and voice mail box regardless of where their workspace is assigned. In addition, present AWS systems do not allow employees to customize aspects of their physical environment, such as the lighting or temperature. Further, while some AWS systems provide employees with directions to their assigned workspaces, present systems provide those directions in two dimensions on the screens of kiosks, and do not provide context sensitive directions, i.e., directions with a specific starting point and specific instructions leading an employee to a final destination. This prevents employees from taking the directions with them or from seeing the route to their workspace in a spatially realistic way.

Present day AWS systems also create other inefficiencies for employers. For example, all modern office buildings are equipped with heating, ventilation and air conditioning (“HVAC”) systems to provide for the comfort and safety of employees. However, there is no provision in present day systems to assign workspaces to employees in a manner so as to minimize the areas that require HVAC systems to be activated. This results in significant waste, both in terms of dollars and environmental impact.

In addition, certain groups of employees may experience higher productivity from frequent collaboration or interaction. For example, a sales person may benefit from being physically proximate to the sales manager, who can provide useful feedback to the employee “face-to-face” on a frequent basis. Present AWS systems do not account for such typical employer needs.

### OBJECTS OF THE INVENTION

Accordingly, it is an object of this invention to provide a system, apparatus, and method for assigning a temporary work space to an employee with environmental parameters, such as lighting and temperature customized to that employee.

Another object of this invention is to provide a system, apparatus, and method for assigning a fixed telephone number and voice mail box to employees assigned a temporary workspace.

Another object of this invention is to provide a system, apparatus, and method for assigning employees to workspaces within a facility in a manner that minimizes the dollar and environmental costs of heating and cooling an office building.

Another object of this invention is to provide directions to an assigned workspace in a manner that allows the employee to refer to the directions on the path to the workspace.

Another object of this invention is to intelligently assign workspaces so that energy consumption can be reduced or optimized.

### SUMMARY OF THE INVENTION

The disclosed invention achieves these objectives by providing alternative work space software that accesses a plurality of databases, including a workspace database, an HR database or data feed and a building database. By accessing these databases, the disclosed AWS software can better assign temporary workspaces to workers. In one embodiment of the invention, a user inputs data into a kiosk describing a desired workspace, the user's instructions are forwarded to a server, and a processor resident in the server accesses a workspace database and a building database to select a suitable workspace matching the user's requests.

One useful function that can be fulfilled by accessing a building database is to select temporary workspaces in such a way as to conserve the usage of energy, such as, for example, by grouping workers in a single section of a building, and not heating the remainder of the building. Accordingly, in another embodiment of the invention, the server retrieves information about the building, such as air handling zones, and uses that information to assign temporary workspaces in a way that reduces energy usage.

In a separate embodiment of the invention, the server also accesses a corporate database containing rules restricting the assignment of workspaces, as well as information describing the user and other employees of a company. These rules and the information contained in the database are then used by the software to select a workspace for the user.

### BRIEF DESCRIPTION OF THE DRAWINGS

Although the characteristic features of this invention will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is a network diagram of a computer information system constructed in accordance with an embodiment of the disclosed invention;

FIG. 2 is an entity relationship diagram describing a software system constructed in accordance with an embodiment of the disclosed invention;

FIG. 3 is a flowchart illustrating high level operations of a software system constructed in accordance with an embodiment of the disclosed invention;

FIG. 4 is a set of directions which could be generated by an embodiment of the disclosed invention;

FIG. 5 illustrates a report showing energy usage on a floor-by-floor basis for an AWS facility managed by software constructed in accordance with an embodiment of the disclosed invention.

### DETAILED DESCRIPTION OF THE ILLUSTRATED EMBODIMENT

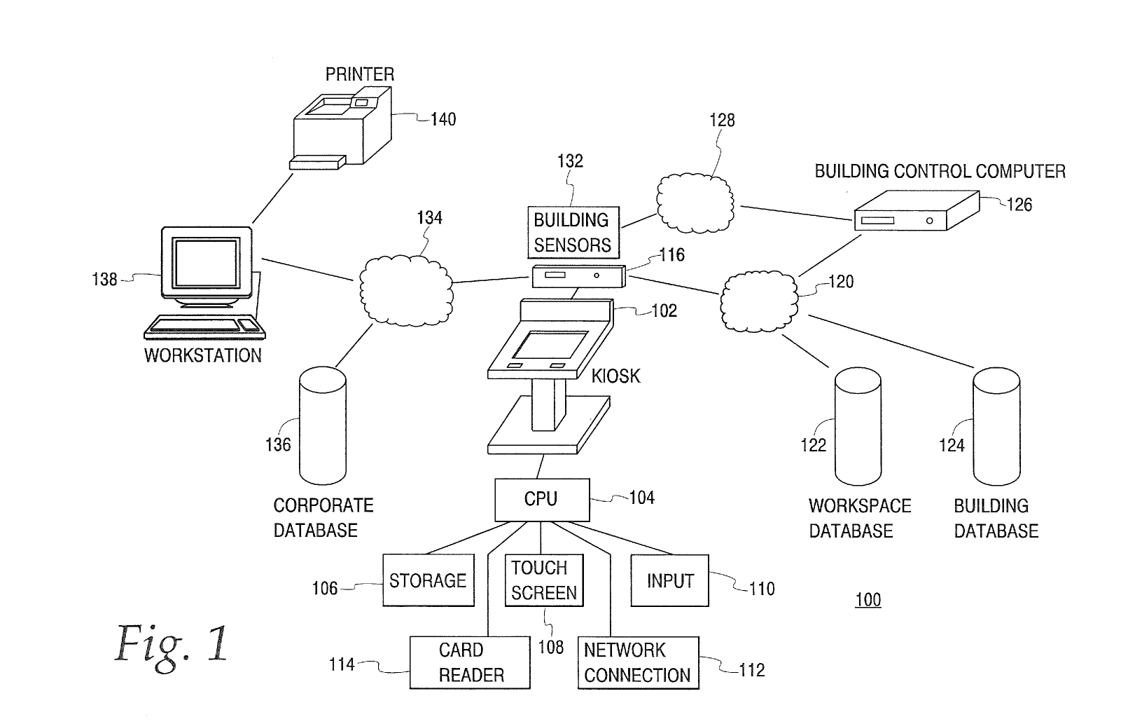

Turning to the Figures, and to FIG. 1 in particular, a computer information system for assigning temporary work spaces to workers sharing an alternative work space (“AWS”) facility is depicted. As explained herein, the disclosed system accesses facility information systems and corporate databases when selecting and configuring temporary workspaces. For example, the disclosed system allows workers to create a profile including their preferred workspace capabilities and environmental settings. When possible, the disclosed system will assign a temporary workspace to workers that meet the preferences of their profile.

After arriving at a shared AWS facility, a user (not shown) approaches kiosk 102 to receive a workspace assignment for the day, or some other period of time. The kiosk could be a custom designed machine as depicted in FIG. 1, or could be a general purpose computer, such as a personal computer, running software constructed in accordance with the disclosed invention. The kiosk 102 of the present illustrated embodiment comprises a processor 104 to execute the user interface of a workspace assignment program, storage 106 to store the user interface program, any other required software, and any associated persistent data, a touch screen display 108 to display options to a user and to accept user input, an input device 110 to accept input in an alternative manner, such as by key press or trackball, a network connection 112 to access the server executing the AWS software 116, and a card reader 114, which is used to identify particular users. In one embodiment, the kiosk could act as a browser interface to an AWS portal exported by the AWS server 116.

The network port 112 is coupled to one or more networks, and primarily provides access to the AWS server. However, the network port 112 may also provide for remote administration and updating of the kiosk 102 in accordance with standard information systems practices. The AWS server 116 can access a corporate database 136 or corporate information systems (not shown) through a first network 134. In addition, the AWS server 116 can access a workspace database 122 and a building database 124 through a second network 120. The AWS server 116 can also access building information systems 126, which monitor building sensors, such as card sensors (not shown) and activate building displays 130. The building systems 130, 132 may utilize a separate network 128 of their own.

From the point of view of a user, the user will swipe a key card on the card reader 114 to initiate the workspace assignment process. When the user swipes her key card, the kiosk will either access internal storage 106 or an external database, such as the corporate database 136, to acquire an information record describing the user. Alternatively, information from the user's key card can be relayed to the AWS server 116, which can respond with the user's profile. The display 108 then displays the user's name, and the user may request a temporary workspace or initiate some other operation. Assuming the user requests a temporary workspace, the kiosk will access the user's preferences, either directly or through the AWS server 116, which may be stored internally in storage 106, or in an external database, such as the workspace database 122, or a separate user database (not shown). User preferences may include, but are not limited to: preferred location, whether a computer is needed, the capabilities of the required computer, whether a phone is needed, the capabilities of the required phone, preferred temperature, and preferred lighting characteristics, i.e., how bright the light in the user's workspace is set, etc.

In addition to user preferences, the AWS server 116 may access a set of assignment rules. Without limitation, these assignment rules may be applied for a defined group of employees, e.g., all sales persons dealing in painkillers, an arbitrary group of employees, i.e., all employees with a last name starting with ‘T’, or a particular employee. Assignment rules are used to give employers flexibility to assign certain employees to workspaces that are close to one another, i.e., so that collaborative projects can be accomplished. In addition, certain employees may be given preferential treatment when being assigned temporary workspaces, i.e., a vice president that works with sales persons once a month may preferentially be assigned an office rather than a small cubicle. Moreover, assignment rules may prohibit the assignment of certain spaces unless certain criteria are met, i.e., conference rooms would not be assigned as temporary workspaces, or, offices would only be assigned to employees with a “ranking” above some level.

To enforce assignment rules, the AWS server 116 may access corporate database 136 to look up certain rule data. For example, to satisfy regulatory requirements or other concerns, a company may require that salespersons selling to governmental entities be physically separated from sales persons selling to corporate customers. The following table summarizes other types of rules that employers may wish to follow when assigning workspaces to employees:

| Purpose of Rule | Description of Rule |
|---|---|
| Heating Savings, | Assign all employees as close to one another as |
| Collaboration | possible |
| Energy Savings | Assign employees to one floor at a time, starting |
| | with the topmost floors. Also assign employees |
| | to “fill up” zones for heating and cooling to |
| | minimize zones with only a few employees in them. |
| Assign near desired | Assign employees based upon their desire to |
| resources | be near a conference room, special company |
| | resource, like a color laser printer, etc. |
| Apply physical | For denser and more open configurations, allow the |
| space constraints/ | business to set preferences like try and keep a space |
| optimizations | between assignments, etc. |

In addition to the corporate database 136 and the workspace database 122, the AWS software can access one or more building databases 124, as well as the internal building information systems 126. This will allow the AWS software to, for example, monitor when employees actually enter and leave the facility, and use this information to better assign workspaces. For example, the AWS software could assign employees with similar arrival and departure times to the same section of a facility. When the last employee in the particular section departed, that section could be “shut down,” i.e., lighting and environmental controls turned off or set to minimum default levels, thereby saving energy.

Once a temporary workspace is selected, the kiosk 102 accesses building information systems 126 to conform the user's selected workspace to the user's preferences. For example, the phone in the assigned workspace would be programmed with the user's assigned phone number, providing phone number portability across whatever workspaces are assigned to the user. Further, in accordance with an aspect of the displayed invention, the display of the assigned phone could be programmed to indicate that the accompanying workspace had been reserved, and could even display the name or employee identification number of the assigned employee. This last feature would allow an employee a convenient mechanism to ensure that she was using the correct workspace. In addition, the user's security permissions would be appropriately set throughout the building, so that the user could access the areas she needed to access but not any other areas. This would be accomplished by accessing the building's information systems 126, which would then program building sensors 132, such as keypads or card readers, to allow the user access to specified areas. Given the need for increased security, it is foreseeable that building security systems would use their own private network 128.

Finally, the kiosk 102 may provide directions to the user to the assigned workspace. Directions may be provided as a map displayed on the kiosk 102 in either two-dimensional or three-dimensional form. If a map is displayed, the kiosk 102 may also display the direction in an animated fashion, so that the user can gain a greater sense of how to reach the assigned workspace. Another way that directions may be relayed to the user is through a text message sent to the user's cell phone (not pictured), an example of which is depicted in FIG. 4. A person of ordinary skill in the art will envision other ways that directions may be relayed to a user. For example, as cellular phones become more capable technological instruments, it is foreseeable that the majority will have three-dimensional rendering capabilities and integrated GPS devices. Directions could be relayed to such a phone by downloading a VRML model to the phone and then guiding the user through the model as the user moves through the facility.

While the above description has referred to the use of a kiosk disposed within the lobby of a facility to act as an assignment portal for the disclosed AWS software, other implementations are also possible. For example, the night before, a user could log onto a web portal using a personal computer. The computer would then perform similar functions as the kiosk, i.e., accepting data from the user and forwarding that data to a server executing AWS software. Alternatively, various communication devices could be used. For example, a voice over Internet Protocol (“VOIP”) phone station, a cell phone or other wireless mobile device, could be used. This would be especially useful if the user had already created a profile using a device with more flexible input and display options, and only needed to reserve a workspace for a particular date and time. For example, a system of automated voice prompts could enable a user to identify herself and the dates and times she required a workspace with her cell phone.

While energy savings have been briefly discussed above, a significant advantage of the disclosed invention is the ability of the AWS software to assign temporary workspaces in a way that reduces or optimizes energy usage. First, the AWS software will have access to the different air handling areas of the building. Using this information, the AWS software can insure that employees are assigned to the minimum number of air handling zones needed to seat them, and therefore, heating or cooling costs for the building can be lowered. Further, in one embodiment of the invention, the AWS software can directly control airflow grates and thermostats throughout the building, and thereby restrict airflow to a more tightly controlled area than a single air handling zone. For example, in a high rise office building, each floor of the building may encompass a separate air handling zone. However, on a weekend, only a fraction of one floor of offices may be used. The AWS software may directly cause the grates on the remainder of the floor to remain closed, thereby lowering the amount of air conditioning required. In a separate embodiment, the AWS software could send a message to the facility maintenance office, and instruct them to close or open dampers to insure that a particular subsection of an air handling zone received air flow.

Obviously, control of air flow works better when attempting to limit cooling of sections of the building, rather than heating, as a certain minimum temperature may need to be maintained to avoid pipes bursting, etc. Even when dealing with heating, however, energy savings can still be realized, as the AWS software will automatically maintain the temperature in occupied air handling zones at a higher, more comfortable, level. Unoccupied air handling zones will be maintained at a minimum temperature to prevent damage to the facility.

Control of lighting and other electrical use can often be segmented even further, and therefore, greater energy savings on a percent basis can be realized. For example, a floor of an office building may be segmented into multiple work areas. Each of the work areas will usually have separate lighting, and therefore, the AWS software will light only those work areas that are occupied, along with the areas that must be traversed to reach the work areas, such as elevators, lobbies, and common areas. In addition, washrooms situated close to occupied work areas, along with other similar building service areas, will remain lit.

In addition, a person of ordinary skill in the art will realize other uses for this invention. For example, another way that energy savings can be realized is, in appropriate buildings, to activate elevators as appropriate for the level of occupancy of the building. For example, in a building with five elevators, an additional elevator could be activated after each 20% occupancy threshold, meaning the fifth elevator would be activated after 80% occupancy was surpassed.

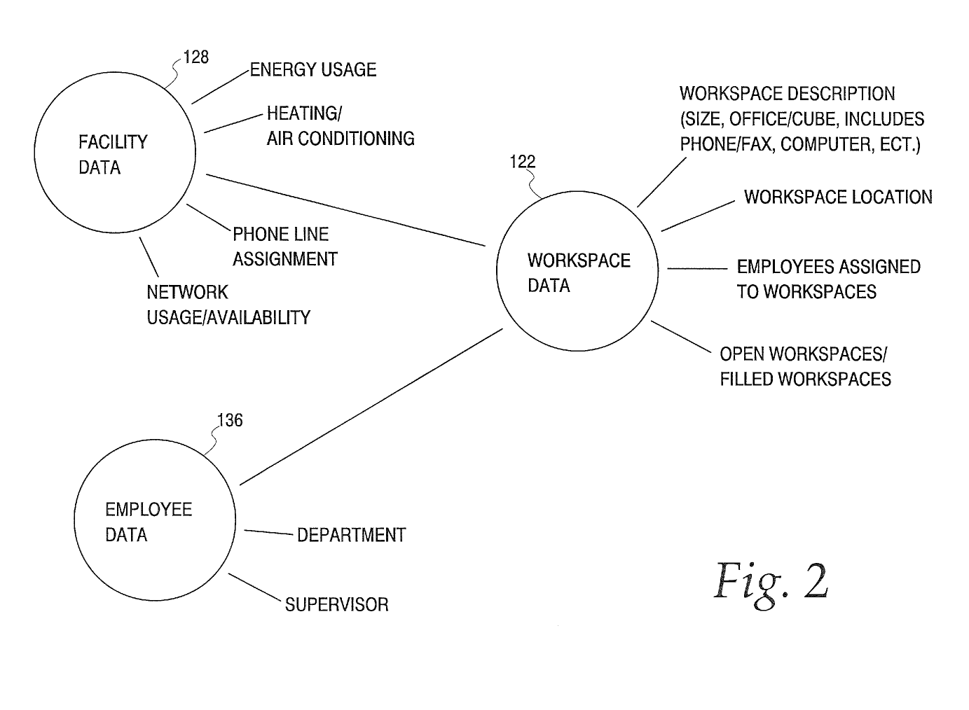

FIG. 2 depicts one possible relationship between data sources used in implementing the disclosed invention. An employee database 136 holds information about employees, at least some of which are assigned temporary workspaces by an alternative workspace system. Information included in the employee database could be the department that a particular employee works in, as well as the employee's supervisor, both of which could be used in determining what workspace to assign to a particular employee. The workspace database 122 holds information about the available workspaces. Included in this database are descriptions of the different workspaces, such as the type of phone that each has access to, as well as a description of the spatial relationship of the workspaces. Numerous methods are available in the prior art to describe the spatial relationship of different areas, such as octrees, or the use of a separate quad-tree for each floor of a facility. A facility database 124 holds information about an AWS facility. Included in this database is information about phone line assignments (i.e., the number assigned to each phone), the location and usability of network ports, heating and air conditioning information, etc. Note that these databases are referred to abstractly, and could in fact be implemented as separate databases, within a single database, or any other conceivable arrangement.

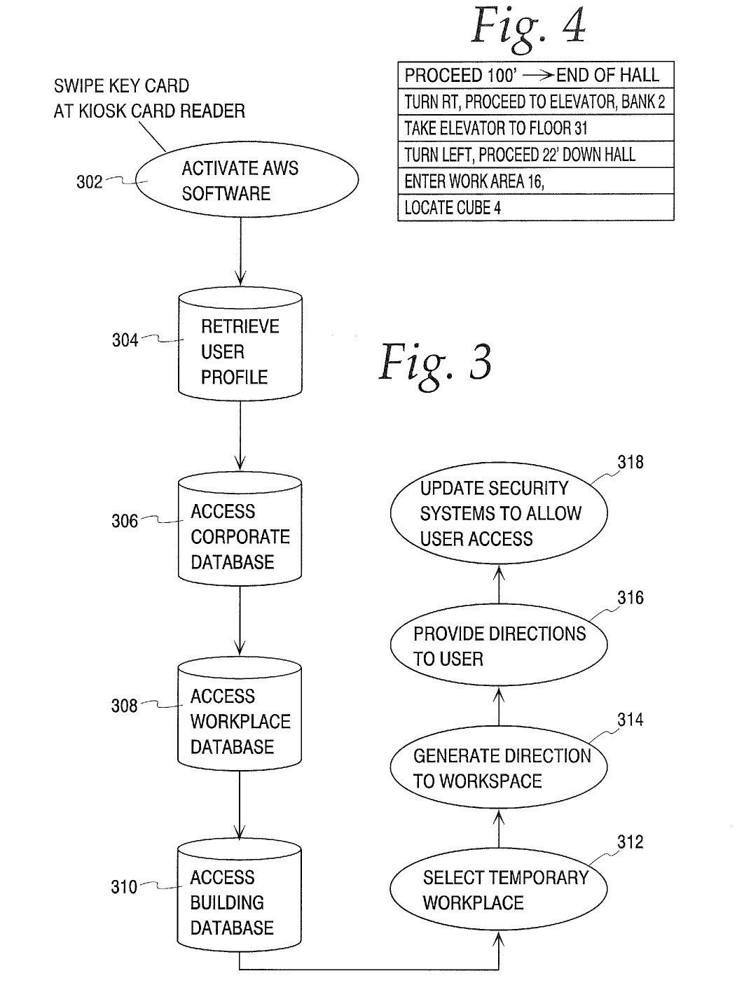

FIG. 3 is a flowchart illustrating an overview of the functions performed by a software system implementing the disclosed invention. In a step 302, a user activates the AWS software. In this context, a user is an employee of a company using a dedicated or shared AWS facility to provide a workspace for the employee. The AWS software could be activated, for example, by the user swiping a key card on a card reader disposed on a kiosk located in the lobby of the AWS facility. Once the AWS software has been activated, the user's profile is retrieved in a step 304. The user's profile will contain information describing the user, as well as the user's preferences. For example, for an AWS facility shared by multiple companies, the user's profile will identify the company that the user works for, and, potentially, will identify a record in the company's corporate database associated with the user.

Once the user's profile has been retrieved, the software accesses an appropriate corporate database 306 to retrieve any placement rules that the employer wants enforced, and to retrieve any other information required to properly place the user. For example, if a corporate placement rule requires the user to be placed within 100′ of his supervisor, the software would retrieve a record associated with the supervisor, so that it could determine where the supervisor was placed. In a step 308, the software accesses a building database, which contains information describing various data points associated with the facility. These data points are used to better select a workspace for the user. In a step 310, the software accesses a workplace database and attempts to select a workplace meeting the user's preferences, any placement rules set by the user's employer, and any other rules used for placing persons.

In a step 312, the AWS software selects a workspace that (1) satisfies all placement rules, and (2) best suits the user's preferences. Optionally, the AWS software may generate directions to the user's temporary workspace in step 314 and provide those directions to the user in a step 316. These directions may take the form of a displayed map, a text message sent to the user's wireless phone, or some other form. FIG. 4 shows one possible set of directions generated by the software and sent to the user as a text message to the user's phone. Finally, in a step 318, security systems within the building may be updated to allow the user access to the areas of the building that the user will require access to. Updated security systems could include card reader lock devices, biometric lock devices, face recognition cameras, etc.

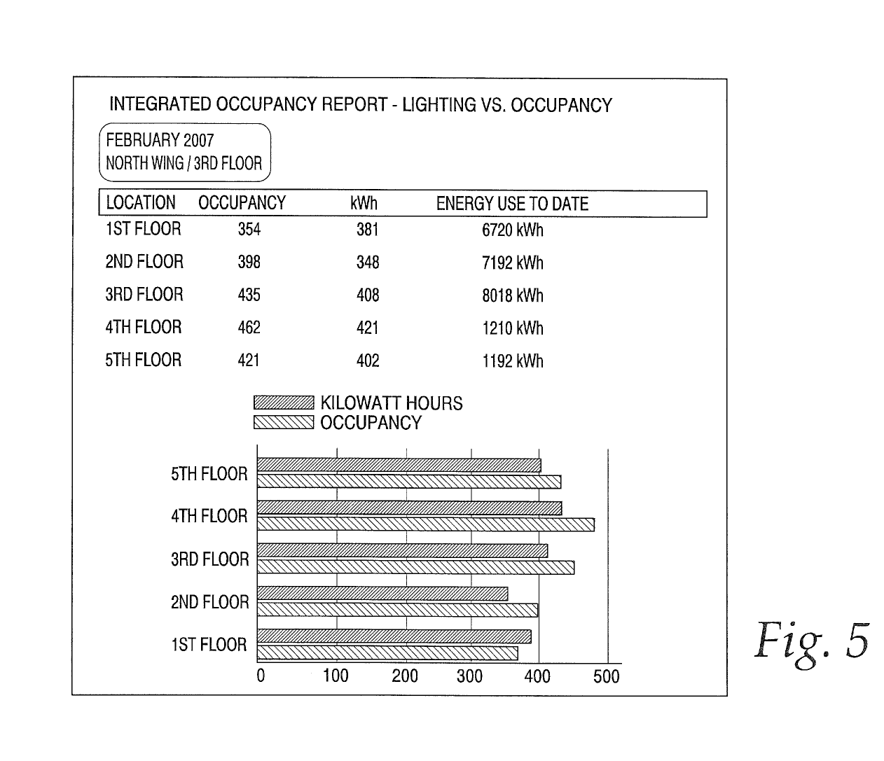

The integration of the AWS software with corporate and building databases also allows for an expanded level of reporting. For example, reports on energy usage by department can be generated, as the AWS software has knowledge not only of the building occupants, but can also access the building information database to retrieve information about energy usage. FIG. 5 depicts another possible report, showing energy usage for lighting of facility managed by the disclosed AWS software on a floor-by-floor basis. In addition, other data points can be tracked. For example, data usage due to voice over IP phones, and department occupancy/absenteeism can be tracked.

The foregoing description of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

1. A system for assigning temporary work spaces to employees sharing a common facility, said system comprising:
i) a workspace database for maintaining data pertaining to available workspaces;
ii) a building database for maintaining data pertaining to at least one building information system;
iii) a kiosk coupled to said workspace database and said building database, said kiosk including a display and an interface adapted for use by a user, said interface allowing a user to input data describing a desired workspace, said kiosk also including a processor, and
iv) one or more workspace assignment rules;
wherein said processor (1) accesses said building database, (2) accesses said workspace database, and (3) selects a suitable temporary workspace for said user based on said user input data, said building database, said workspace database, and said one or more workspace assignment rules.

2. The system of claim 1, wherein said processor accesses said building database to determine energy consumption at one or more levels of occupancy for one or more work areas of said common facility, and wherein said processor selects a suitable temporary workspace for said user based in part on the energy consumption of a work area where said temporary workspace is located.

3. The system of claim 1, further comprising an employee database for maintaining information about employees sharing said common facility, and wherein said processor accesses said employee database and selects a suitable temporary workspace for said user based on said user input data, said building database, said workspace database, and said employee database.

4. The system of claim 3, wherein said processor accesses said employee database and determines if said user belongs to one or more groups of employees, and based on any groups that said user belongs to, selects a temporary workspace for said user.

5. The system of claim 4, wherein said processor selects a temporary workspace for said user that is spatially proximate to other members of at least one group said user is a member of.

6. The system of claim 5, wherein said processor accesses said building database to determine energy consumption for one or more work areas of said common facility when said one or more work areas are fully occupied, and wherein said processor selects a suitable temporary workspace for said user based in part on the energy consumption of the work area where said temporary workspace is located.

7. A method for assigning temporary work spaces to employees sharing a common facility, said method operating on a server including a processor, said server exporting a workspace assignment portal, said method comprising the steps of:
i) accepting input from a user through said workspace assignment portal;
ii) accessing a building database;
iii) accessing a workspace database; and
iv) selecting a suitable temporary workspace for said user based on said input, said building database, said workspace database, and one or more workspace assignment rules.

8. The method of claim 7, further comprising the steps of calculating directions from a point to said selected temporary workspace, and providing said directions to said user.

9. The method of claim 8, wherein said directions are provided in the form of a map displayed on a display.

10. The method of claim 9, wherein said directions are provided on an animated three-dimensional map displayed on said display, and wherein a route to said selected temporary workspace is displayed by said animated three-dimensional map.

11. The method of claim 8, wherein said directions are provided to said user on a wireless device.

12. The method of claim 11, wherein said directions are provided to said user by sending a text message to said wireless device.

13. The method of claim 7, further comprising the steps of tracking air flow zones within said common facility, and assigning temporary workspaces within a first air flow zone before assigning temporary workspaces within a second air flow zone.

14. The method of claim 7, further comprising the step of generating a report based on said building database and a corporate database.

15. The system of claim 4 wherein one of said workspace assignment rules selects a temporary workspace for said user that is spatially proximate to a workspace assigned to the user's supervisor.

16. The system of claim 1 further comprising one or more elevators and an interface to a building information system that allows control over said elevators and wherein said processor maintains a number of assigned workspaces and activates at least one of said elevators based on the number of assigned workspaces.

17. The system of claim 1 further comprising a multi-story building and wherein one of said workspace assignment rules requires that employees are assigned to workspaces on a topmost floor before employees are assigned to workspaces on a lower floor.

18. The system of claim 1 further comprising one or more air flow zones and wherein one of said workspace assignment rules requires that workspaces within a first air flow zone are assigned before workspaces within a second air flow zone are assigned.

19. The system of claim 1 wherein one of said workspace assignment rules requires assigning employees in workspaces proximate to one another.

20. The system of claim 19 further comprising a plurality of work areas and wherein one of said workspace assignment rules requires that a first work area is filled before placing said user in a second work area.

21. The system of claim 20 further comprising an interface to a building information system that allows control over building functions including lighting for said one or more work areas, and wherein said processor will utilize said interface to the building information system to activate lighting for a work area only after at least one workspace has been assigned in that work area.

22. The system of claim 21 further comprising one or more washrooms each associated with at least one of said work areas and wherein said processor utilizes said interface to the building information system to activate lighting for each washroom associated with a work area that has at least one assigned workspace.

23. The system of claim 20 further comprising one or more airflow dampers and an interface to a building information system that allows control over said airflow grates wherein said processor utilizes said interface to the building information system to open airflow dampers providing airflow to a work area only after at least one workspace has been assigned in that work area.

24. The system of claim 20 further comprising one or more thermostats and an interface to a building information system that allows control over said thermostats wherein said processor utilizes said interface to maintain a higher temperature in occupied work areas than unoccupied work areas.

25. The system of claim 24 wherein said processor maintains unoccupied work areas at a minimum temperature.

26. The system of claim 1 further comprising one or more shared resources and wherein one of said workspace assignment rules requires that employees are assigned to workspaces spatially proximate to said one or more shared resources.

27. The system of claim 26 wherein at least one of said shared resources is a color laser printer.

28. The system of claim 26 wherein at least one of said shared resources is a conference room.

29. The system of claim 1 further comprising one or more security systems to control access to the common facility and an interface to a building information system to monitor employees using said security systems to access said common facility and wherein said processor accesses said building information system to determine normal arrival and departure times for said user and assigns said temporary workspace based on said normal arrival and departure times for said user.

30. The system of claim 29 wherein said processor assigns employees with similar arrival and departure times spatially proximate to one another.

31. The method of claim 7 further comprising the steps of accessing an employee database maintaining information about employees sharing said common facility, determining if said user belongs to one or more groups of employees, and wherein one of said workspace assignment rules requires that a temporary workspace for the user is selected based on any groups that said user belongs to.

32. The method of claim 31 further comprising the step of selecting a temporary workspace for said user that is spatially proximate to other members of at least one group said user is a member of.

33. The method of claim 32 wherein said step of selecting selects a temporary workspace for said user that is spatially proximate to a workspace assigned to the user's supervisor.

34. The method of claim 7 further comprising the steps of accessing said building database to determine energy consumption for one or more work areas of said shared facility when said work areas are fully occupied and selecting a temporary workspace for said user based at least in part on the energy consumption of the work area where said temporary workspace is located.

36. The method of claim 7 wherein said shared facility further comprises one or more elevators and an interface to an elevator control system that allows control over said elevators, said method further comprising the step of activating at least one of said elevators based on a number of assigned workspaces.

37. The method of claim 7 wherein said shared facility further comprises a multi-story facility and wherein one of said workspace assignment rules requires that employees are assigned to workspaces on a topmost floor before employees are assigned to workspaces on a lower floor.

38. The method of claim 7 wherein said shared facility further comprises one or more air flow zones and wherein one of said workspace assignment rules requires that workspaces within a first air flow zone are assigned before assigning workspaces within a second air flow zone.

39. The method of claim 7 wherein said shared facility further comprises a plurality of work areas and wherein one of said workspace assignment rules requires that a first work area is filled before placing said user in a second work area.

40. The method of claim 39 wherein said shared facility further comprises a building system interface that allows control over building functions including lighting for one or more of said work areas and said method further comprising the step of activating lighting for a work area only after at least one workspace has been assigned.

41. The method of claim 39 wherein said shared facility further comprises one or more airflow dampers and an interface to a building information system that allows control over said airflow dampers and said method further comprising the step of opening airflow dampers providing airflow to a work area only after at least one workspace in that work area has been assigned.

42. The method of claim 39 wherein said shared facility further comprises one or more thermostats and an interface to a building information system that allows control over said thermostats and said method further comprising the step of maintaining a higher temperature in occupied work areas than in unoccupied work areas.

43. The method of claim 42 further comprising the step of maintaining unoccupied work areas at a minimum temperature.

44. The method of claim 7 wherein said shared facility further comprises one or more shared resources and wherein one of said workspace assignment rules requires that employees are assigned to workspaces spatially proximate to said one or more shared resources.

45. The method of claim 44 wherein at least one of said shared resources is a color laser printer.

46. The method of claim 45 wherein at least one of said shared resources is a conference room.

47. The method of claim 7 wherein said shared facility further comprises one or more security systems to control access to said shared facility and an interface to a building information system to monitor employees using said security system to access said shared facility and said method further comprises the steps of accessing said building information system to determine normal arrival and departure times for said user and wherein one of said workspace assignment rules requires that said user is assigned a temporary workspace based on said normal arrival and departure times.

48. The method of claim 47 wherein one of said workspace assignment rules requires that employees with similar arrival and departure times are assigned temporary workspaces spatially proximate to one another.
